(19) United States
(12) Patent Application Publication
(10) Pub. No.: US 2013/0166460 A1
(43) Pub. Date: Jun. 27, 2013

(54) System to Manage Patents in an Enterprise

(71) Applicants: Santosh Kumar Mohanty, Mumbai (IN); Akhilesh Chandra Srivastava, Mumbai (IN)

(72) Inventors: Santosh Kumar Mohanty, Mumbai (IN); Akhilesh Chandra Srivastava, Mumbai (IN)

(73) Assignee: TATA CONSULTANCY SERVICES LIMITED, Mumbai (IN)

(21) Appl. No.: 13/427,024

(22) Filed: Mar. 22, 2012

(30) Foreign Application Priority Data
Dec. 24, 2011 (IN) 3654/MUM/2011

(51) Int. Cl. G06Q 50/00

(52) U.S. Cl. 705/310

(57) ABSTRACT

The present subject matter discloses systems and methods for managing patents in an enterprise. In one implementation, the method for patent management in the enterprise comprises defining an enterprise patent service set of a plurality of enterprise patent services, wherein the enterprise patent services set comprises portfolio service, process service, and program service, and defining an enterprise patent capability set of a plurality of enterprise patent capabilities, for delivering each of the enterprise patent services in the enterprise patent service set, wherein the enterprise patent capability set comprises promote, profit and protect. The method further comprises mapping each of the enterprise patent services in the enterprise patent service set with each of the enterprise patent capabilities in the enterprise patent capability set so as to generate an objective for each pair of enterprise patent service and enterprise patent capability.

### TECHNICAL FIELD

The present subject matter relates, in general, to patent management and, in particular, to systems and methods for managing patents in an enterprise.

### BACKGROUND

Intellectual Property (IP) rights refer to intangible property rights or legal rights associated with intellectual activity in industrial, scientific, artistic, and literary fields. IP rights comprise valuable strategic and financial assets for every enterprise. There are various forms of IP rights, such as patents, trademarks, industrial designs, plant variety protection, copyright; and confidential information or trade secrets. Each form of IP rights provides the owner of the IP rights with varied privileges. For example, a patent is the right granted by a jurisdiction, i.e. the government of a country, to the patent owner, to exclude others from commercially exploiting the invention within that jurisdiction. In general, commercial exploitation includes making, using, importing, offering for sale, selling a product or a service.

The IP rights usually provide for the safeguarding the interest and the investments made by an enterprise in creating the intellectual property. For example, an enterprise may have invested large capital, say in developing infrastructure, investing in manpower, etc.; and a lot of man hours to innovate and create intellectual property. IP rights provide a mechanism of providing high return on the investments, thus encouraging enterprises to innovate.

The IP rights acquired by an enterprise provide various business opportunities to the enterprise. The right to exclude others from commercially exploiting the IP rights owned by the enterprise provides a competitive edge to the enterprise over other key players. Further IP rights may also provide various revenue generating opportunities and facilitate strategic decision making For example, some enterprises may license their IP rights to selected entities in return of licensing fees and royalty fees. Certain enterprises use the acquired IP rights to negotiate cross licensing, thus allowing the enterprises to access and use IP rights of other enterprises. Some enterprises use IP rights for collaboration of research and development (R & D) activities with other enterprises and institutes.

Further, certain enterprises acquire and use IP rights to influence the activities of various stakeholders, such as suppliers, assembly units, testing centers, in a product development model and thus, gain a competitive advantage over other key players. Moreover, some enterprises also use IP rights for branding. For example, enterprises mention the details pertaining to applied for IP rights or acquired IP rights in their advertising media so as to demonstrate their technical supremacy and expertise in a domain.

However, though the returns are high, acquiring and protecting IP rights is a cost intensive process. In recent times, the industry appreciates that innovation plays a role not just in product and service development but in every process of the enterprise. This has led to enterprises having formal mechanisms to capture information pertaining to these processes and defining best practices. With the increasing economic relevance of IP rights, many enterprises focus on generating, acquiring, protecting, valuating and managing IP rights.

### SUMMARY

This summary is provided to introduce concepts related to systems and methods of managing patents in an enterprise and the concepts are further described below in the detailed description. This summary is neither intended to identify essential features of the claimed subject matter nor is it intended for use in determining or limiting the scope of the claimed subject matter.

In one implementation, the method for patent management in the enterprise comprises defining an enterprise patent service set of a plurality of enterprise patent services, wherein the enterprise patent services set comprises portfolio service, process service, and program service, and defining an enterprise patent capability set of a plurality of enterprise patent capabilities, for delivering each of the enterprise patent services in the enterprise patent service set, wherein the enterprise patent capability set comprises promote, profit and protect. The method further comprises mapping each of the enterprise patent services in the enterprise patent service set with each of the enterprise patent capabilities in the enterprise patent capability set so as to generate an objective for each pair of enterprise patent service and enterprise patent capability.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network environment implementing a patent management system, according to an embodiment of the present subject matter.

FIG. 2 illustrates the patent management system, according to an embodiment of the present subject matter.

FIG. 3 illustrates a framework for managing patents in an enterprise, according to an embodiment of the present subject matter

FIG. 4 illustrates an exemplary method of generating a role based activity for managing patents in an enterprise, according to an embodiment of the present subject matter

FIG. 5 illustrates an exemplary method of determining a maturity index, according to an embodiment of the present subject matter

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods of managing patents in an enterprise are described herein. The systems and methods can be implemented in a variety of computing systems. Examples of such computing systems include, but are not restricted to, mainframe computers, workstations, personal computers, desktop computers, minicomputers, servers, multiprocessor systems, laptops, network servers, and the like.

Enterprises usually accumulate intellectual property (IP) rights in a planned manner. Usually an enterprise has domains and technology in which the enterprise conducts a major portion of its business. Further an enterprise may identify the major jurisdictions in which the enterprise has its operations, and markets. Based on the domain and technology; jurisdiction; market share, etc., the enterprise usually explores means to gain a competitive advantage over other key players. One way of gaining the competitive advantage is to develop a strong IP portfolio in each of the selected domains and jurisdictions. The IP portfolio may be developed using various techniques such as patents.

There are various challenges involved in managing IP of the enterprise, especially patents. The challenges may arise at any stage of the patent lifecycle, such as creating the intellectual property, applying for and obtaining the patent, protecting the patent, utilizing and exploiting the patent and enforcing the patent. Also since patents are territorial rights and the requirements of each jurisdiction, the rights provided by each jurisdiction, etc., vary, managing patents in an enterprise becomes a daunting task.

Further, it is very challenging to implement IP promotion policies in an enterprise. Usually, the advantages of having a strong patent portfolio; in terms of attracting outside investors, establishing an enterprise as a leader in a domain, generating possible licensing revenue; are often overlooked or are underestimated by the various stakeholders of the enterprise, till the enterprise becomes involved in lengthy and costly litigation.

Moreover, generating patent applications in an enterprise usually involves a collective endeavor that often involves huge research and development (R&D) investment funded by the enterprise. In order to protect their R&D investment, the enterprises may need to ensure that the enterprise is assigned the rights of all the work created by their employees and independent contractors. To accomplish this, the enterprise may need to develop expertise in understanding the regulations of what can be protected and how the protection may be obtained within their respective jurisdiction. The enterprise may also obtain executed, legally binding agreements with all employees and outside consultants, assigning all such IP rights to the enterprise. In the absence of such agreements, the enterprise may jeopardize the ownership of valuable IP rights. However, in midst of all such agreements and associated negotiations, the stakeholders of the enterprise may lose focus and fail to align R & D activities with the enterprise's business needs and objectives.

After creation of IP rights, an enterprise usually focuses on protecting the same in various jurisdictions and attempts to generate revenue out of the protected IP rights. Generating revenue from IP rights usually involves enforcement of the IP rights by the enterprise. Enforcement of IP rights by the enterprise prevents the commercial exploitation of the same by others. Usually enforcement involves litigation and/or negotiations with other key players in a jurisdiction. Thus enterprises usually attempt to design and implement IP management programs and policies that aim to protect the existing intellectual property and enhance the creation of further intellectual property, such as patents.

The present subject matter describes systems and methods for managing patents in an enterprise. It should be appreciated by those skilled in the art that though the systems and methods for quality monitoring are described in the context of managing patents in an enterprise, the same should not be construed as a limitation. For example, the systems and methods for managing patents in an enterprise may be implemented for various other purposes, such as for generating and implementing various frameworks of patent management, evaluating a patent portfolio, and determining the maturity level of an enterprise in managing patents.

In one implementation, a patent management system is configured to implement a ‘3P×3P’ strategy framework for managing patents in an enterprise. In said implementation, the ‘3P×3P’ framework involves defining a plurality of enterprise patent services, a plurality of enterprise patent capabilities to deliver these enterprise patent services, and mapping objectives at each cross section of an enterprise patent service and an enterprise patent capability. In one implementation, the enterprise patent services include portfolio, process, and program; and the enterprise patent capabilities include promote, protect, and profit.

In one configuration, the patent management system generates a ‘RAM’ framework to execute the ‘3P×3P’ strategy framework. The ‘RAM’ framework provides for definitions of roles of various stakeholders involved in patent management, mapping of activities to each of the defined roles, and measurements to monitor the progress of maturity of the enterprise in patent management.

Further, the patent management system is configured to generate a ‘DEEP’ maturity framework for defining the maturity level of each duplet of enterprise patent service and enterprise patent capability. In said implementation, the ‘DEEP’ maturity framework comprises of four stages of maturity; namely ‘Defined’, ‘Established’, ‘Excel’, and ‘Pioneer’. In said implementation, the patent management system is further configured to determine a maturity index, indicative of the maturity of each duplet of enterprise patent service and enterprise patent capability based on pre-configured rules. In one embodiment, the patent management system may be configured to determine if a pair of enterprise patent service and enterprise patent capability has attained the objective required at various maturity levels. Moreover, in one implementation, the patent management system may be further configured to determine the overall status of maturity level achievement for all pairs of enterprise patent service and enterprise patent capability.

Thus, the systems and methods for managing patents in an enterprise facilitate the maturing of patent management services and capabilities of the enterprise. These and other features of the present subject matter would be described in greater detail in conjunction with the following figures. While aspects of described systems and methods for the quality monitoring can be implemented in any number of different computing systems, environments, and/or configurations, the embodiments are described in the context of the following exemplary system(s).

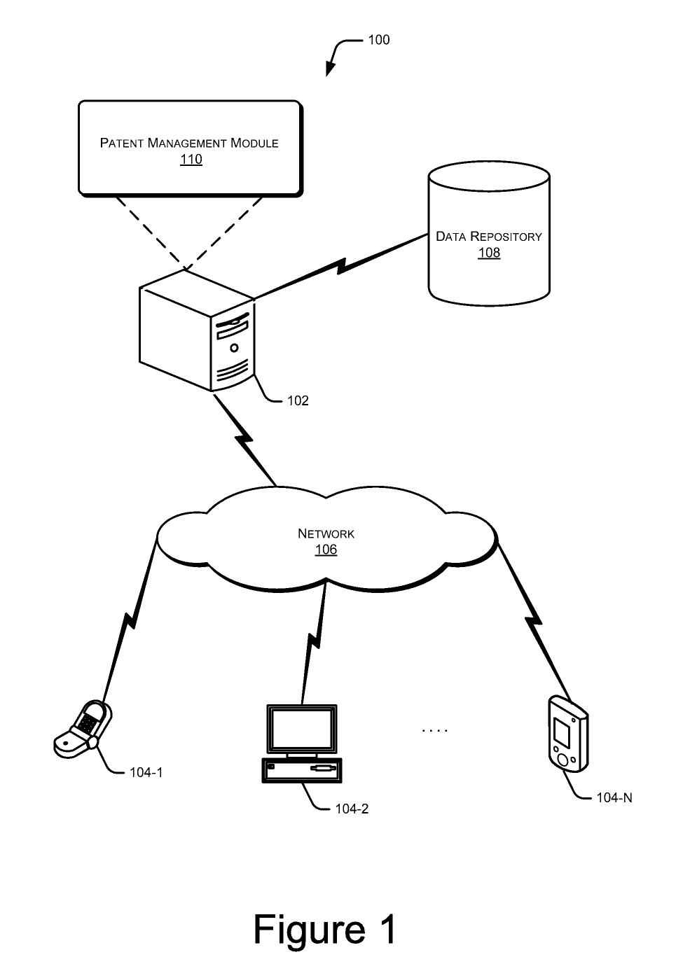

FIG. 1 illustrates a network environment 100 implementing a patent management system 102, according to an embodiment of the present subject matter. In said embodiment, the network environment 100 includes the patent management system 102 configured for managing patents in an enterprise. In one implementation, the patent management system 102 may be included within an existing information technology infrastructure or an existing intellectual property management system of an enterprise. For example, the patent management system 102 may be interfaced with the existing content and document management system(s), database and file management system(s), of the enterprise.

The patent management system 102 may be implemented in a variety of computing systems, such as a laptop computer, a desktop computer, a notebook, a workstation, a mainframe computer, a server, a network server, and the like. It will be understood that the patent management system 102 may be accessed by users through one or more client devices 104-1, 104-2, 104-3 . . . 104-N, collectively referred to as client devices 104. Examples of the client devices 104 include, but are not limited to, a desktop computer, a portable computer, a mobile phone, a handheld device, a workstation. The client devices 104 may be used by various stakeholders of patent management in the enterprise such as IP analysts, IP consultants, IP managers, IP Program Head, inventors and system administrators. As shown in the figure, such client devices 104 are communicatively coupled to the patent management system 102 through a network 106 for facilitating one or more end users to access and operate the patent management system 102.

The network 106 may be a wireless network, wired network or a combination thereof. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include a variety of network devices, including routers, bridges, servers, computing devices, storage devices, etc.

In one implementation, the patent management system 102 is communicatively coupled to a data repository 108 either directly or through the network 106. The data repository 108 may store or provide access to various published patent applications, granted patents, prosecution and litigation history of the patent applications and granted patents, of various jurisdictions such as India, The United States of America, Europe, Great Britain, Japan, Australia, Korea, Republic of China and Australia. Further, the data repository 108 may also store or provide access to various non patent literatures published in form of academic papers, research papers, journals, product brochures, white papers, case studies and so on.

In one embodiment, the patent management system 102 includes a patent management module 110 configured for managing patents in an enterprise. In said embodiment, the patent management module 110 may be configured to generate various workflows to facilitate patent management based in part on inputs provided by various stakeholders of patent management in the enterprise. In one implementation, the patent management module 110 is configured to facilitate administration of various processes pertaining to filing, prosecution, grant procedures, post-grant formalities, etc., of a patent application.

The patent management module 110 may be further configured to generate various workflows pertaining to development of patent portfolio of the enterprise. In one embodiment, the patent management module 110 facilitates aligning of business initiatives with acquisition of patents, landscape analysis, protecting a domain or technology using a cluster of patents, mapping patents with business offerings, etc.

In one implementation, the patent management module 110 may be configured to compute the value of the patent portfolio of the enterprise based on various valuation techniques as would be known by those skilled in the art. The patent management module 110 may be further configured to determine a maturity index, indicative of the maturity level of each cross section of service and capability based on pre-configured rules.

In one embodiment, the patent management module 110 may be configured to generate various reports indicative of processes, workflows, maturity level of the enterprise in managing patents. Thus the patent management system 102 facilitates managing patents in an enterprise. Further, the patent management system 102 may be configured to implement various frameworks, workflows, strategy, etc., for managing patents in the enterprise.

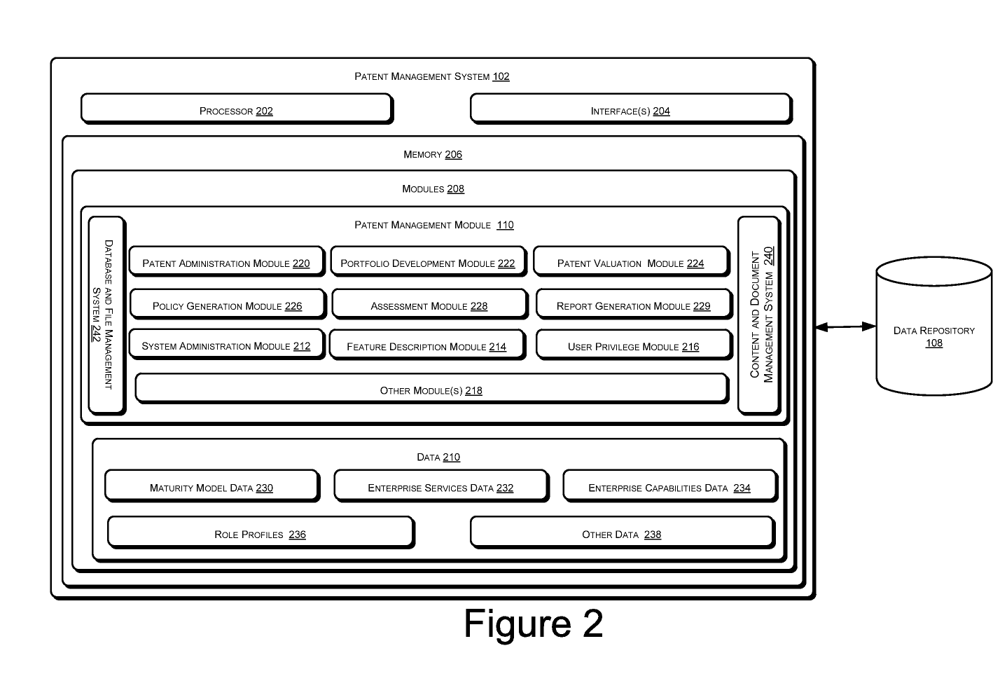

FIG. 2 illustrates the exemplary components of the patent management system 102, according to an embodiment of the present subject matter. In one embodiment, the patent management system 102 includes a processor 202 interface(s) 204, and a memory 206 coupled to the processor(s) 202. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions stored in the memory 206.

The interface(s) 204 may include a variety of software and hardware interfaces, for example, a web interface, a graphical user interface, etc., allowing the patent management system 102 to interact with the client devices 104. Further, the interface(s) 204 may enable the patent management system 102 to communicate with other computing devices, such as web servers and external data servers (not shown in figure). The interface(s) 204 can facilitate multiple communications within a wide variety of networks and protocol types, including wired networks, for example LAN, cable, etc., and wireless networks such as WLAN, cellular, or satellite. The interface(s) 204 may include one or more ports for connecting a number of devices to each other or to another server.

The memory 206 can include any computer-readable medium known in the art including, for example, volatile memory (e.g., RAM), and/or non-volatile memory (e.g., EPROM, flash memory, etc.). In one embodiment, the memory 206 includes module(s) 208 and data 210. The module(s) 208 usually includes routines, programs, objects, components, data structure, etc., that perform particular task or implement particular abstract data types.

In one implementation, the modules 208 further include the patent management module 110, a system administration module 212, a feature description module 214, and a user privilege module 216. The modules 208 may also include other modules 218 for providing various other functionalities of the patent management system 102. In one implementation, the patent management module 110 further comprises a patent administration module 220, a portfolio development module 222, a patent valuation module 224, a policy generation module 226, an assessment module 228 and a report generation module 229. It will be appreciated that such modules may be represented as a single module or a combination of different modules. Additionally, the memory 206 further includes data 210 that serves, amongst other things, as a repository for storing data fetched, processed, received and generated by one or more of the modules 208. In one implementation, the data 210 may include, for example, maturity model data 230, enterprise patent services data 232, enterprise patent capabilities data 234, role profiles 236, and other data 238. In one embodiment, the data 210 may be stored in the memory 206 in the form of data structures. Additionally, the aforementioned data can be organized using data models, such as relational or hierarchical data models.

As mentioned earlier, the patent management system 102 may be accessed by various stakeholders of patent management in the enterprise such as IP analysts, IP consultants, IP managers, IP Program Head, inventors and system administrators using the client devices 104. In one implementation, the user privilege module 216 may be configured to implement various access control mechanisms for the various stakeholders of patent management in the enterprise, based on data stored as role profiles 236. The user privilege module 216 may be configured to restrict access to various modules 208 and/or data 210, based on the privileges provided to the stakeholder. In one implementation, various details pertaining to the stakeholder, such as login credentials, access permissions, and personal details may be stored as role profiles 236. Further, the system administration module 212 of the patent management system 102 may be configured to facilitate carrying out of various administrative and maintenance task pertaining to the patent management system 102.

In one embodiment, the feature description module 214 provides information about various functionalities of the patent management system 102, instructions and tips on how to user various modules 208 of the patent management system 102 and so on. In one implementation, the access to information provided by the feature description module 214 may be based on the privileges of the stakeholder as retrieved from the role profiles 236.

In operation, the stakeholders of patent management in the enterprise having requisite privileges may use the patent administration module 220 to define various workflows such as Idea to Invention Disclosure File (IDF) workflow, IDF to filing of patent application workflow, prosecution workflow, litigation workflow, incentive management, expense management, and attorney interaction management.

For example, the Idea to Invention Disclosure File (IDF) workflow may involve filling up of an invention disclosure sheet by an inventor and a subsequent review of the same by one or more stakeholders of patent management of the enterprise. The review may include opinions pertaining to the novelty of the idea, business value of the idea, possible business goals which may be met or which may be set based on the idea, products and services of the enterprise and other key players which may be impacted by the idea and so on. Similarly, the IDF to filing of patent workflow may involve drafting of a patent application based on the invention disclosure sheet and in accordance with the statutes and rules of a jurisdiction by in-house or outside counsels. The IDF to filing of patent workflow may also include compliance with various other statutes and rules of the enterprise, for example timely submission of forms and completion of formalities. The prosecution workflow may involve responding to office actions issues by the jurisdiction, and completing other actions requested by the jurisdiction leading to the grant of the patent or final rejection of the patent application.

Further, the patent administration module 220 may also facilitate awarding incentives to the inventors, for example in form of recognition, monetary rewards; so as to encourage innovation and promote filing of patent applications in an enterprise. The patent administration module 220 may also be configured to manage relations with external attorneys, who have been assigned to do various work related to acquiring patents by the enterprise. For example, the patent administration module 220 may be configured to track the cases assigned to external attorneys, manage invoicing and billing requested by the external attorneys and so on. Moreover, the patent administration module 220 may also be configured to manage litigation pertaining to the patent applications or granted patents of an enterprise. Such litigation may include defense against revocation, enforcing patent rights by establishing infringement of patents of the enterprise, and so on.

The portfolio development module 222 of the patent management system 102 may be configured to facilitate the development of patent portfolio of the enterprise in domains and jurisdictions determined by the business objectives of the enterprise. In one implementation, the portfolio development module 222 may be configured to retrieve data from the data repository 108 so as to perform a landscape analysis. Landscape analysis usually refers to a comprehensive analysis of granted patents, published patent applications and non patent literature, such as academic papers, and scientific literature, in selected domains and technology areas. The portfolio development module 222 may be configured to highlight white space in the selected domains and technology areas. The portfolio development module 222 may be further configured to facilitate planning of R&D activities, identify the global activities of other key players and provide insight to strategies & strengths. The portfolio development module 222 may also facilitate the user to identify technological advances in selected domains and technology areas, identify new players in the selected domain and technology area. The portfolio development module 222 may also help the various stakeholders of patent management to identify potential avenue for mergers and/or acquisitions.

In one implementation, the portfolio development module 222 may be configured to facilitate patent portfolio to product mapping so as to assist the various stakeholders of patent management in determining the alignment of the patent portfolio of the enterprise with the products and services provided by the enterprise. The portfolio development module 222 may be configured to identify important patents from the enterprise's patent portfolio which are mapped to the enterprise's services and products; to determine potential infringing patent from other key players' pool of patents which may be mapped to one or more products and services provided by the enterprise.

In one implementation, the analysis made by the portfolio development module 222 may be further enhanced using the patent valuation module 224. The patent valuation module 224 may be configured determine the valuation of the patent portfolio of the enterprise. In one implementation, the patent valuation module 224 may be configured to fetch the list of patents owned by the enterprise and compare the same with list of patents owned by other key players so as to the economic value of the patent portfolio of the enterprise. In general, the value of the patent portfolio is indicative of the commercial utility that can be extracted from the use of the patent portfolio. In one implementation, the patent valuation module 224 may assign a weightage parameter, indicative of the level of importance, of each feature of the enterprise's patent portfolio, such as the patent family size, the lifespan of a patent, the outcome of oppositions to the patent application, the number, scope, type and quality of claims, and the volume of prior art available or cited.

The patent valuation module 224 may be configured to determine the value of the patent portfolio of the enterprise based on either or both of quantitative and qualitative aspects. In one implementation, the patent valuation module 224 may be configured to determine the value of patent portfolio of the enterprise based on conventionally known techniques, such as cost method, market method, and income method. Based on the evaluation, the stakeholders of patent management in the enterprise may aim to enhance and/or sustain the IP rights owned by the enterprise.

In one implementation, the policy generation module 226 of the enterprise is configured to devise strategies and framework for enhancing the IP rights owned by the enterprise. In one implementation, the policy generation module 226 may be configured to generate a ‘3P×3P’ strategy framework for managing patents in the enterprise.

In one implementation, the policy generation module 226 may be configured to identify three classes of enterprise patent services namely, portfolio services, process services, and program services. In one implementation, the various enterprise patent services may be saved as enterprise patent services data 232. In said implementation, the portfolio services refer to the design services through which the enterprise strategizes its patent initiative for long term sustainability. The policy generation module 226 is further configured to define, for every portfolio service, at least one process service that depicts the process to perform the said portfolio service. In said implementation, the policy generation module 226 may further define, for every portfolio service, at least one program service that assures the portfolio service is implemented across the enterprise.

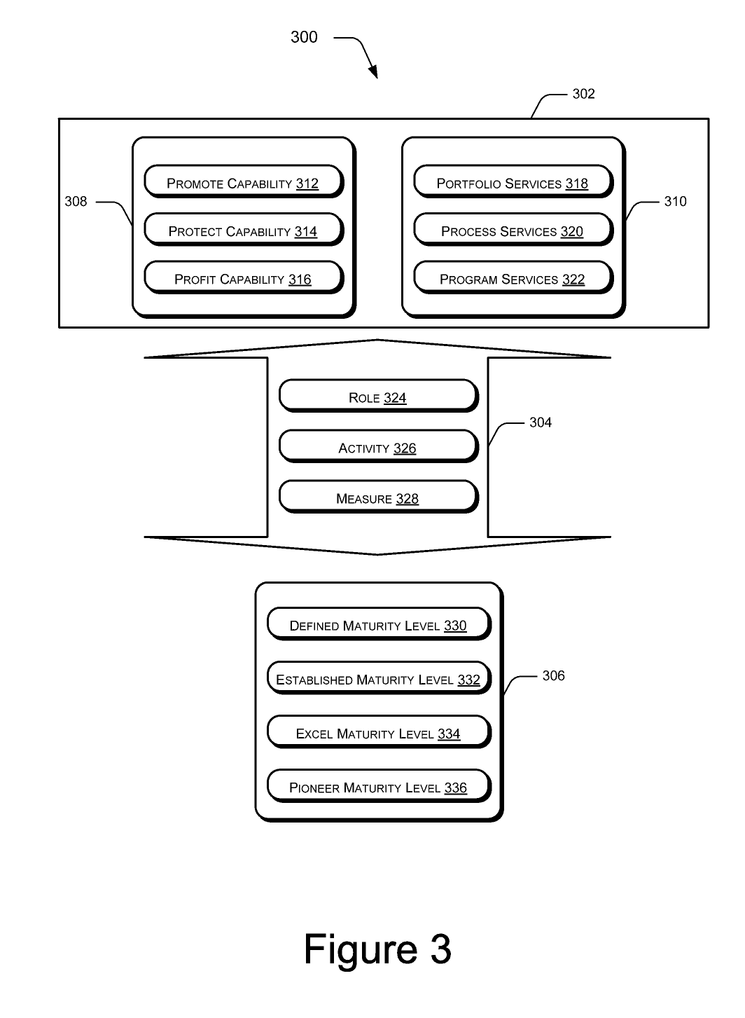

In one implementation, the policy generation module 226 may be configured to define one or more enterprise patent capabilities to effectively deliver the enterprise patent services. In one configuration, the policy generation module 226 may define three classes of the enterprise patent capabilities namely, promote capabilities, protect capabilities, and profit capabilities and the same may be saved as enterprise patent capabilities data 234. In one embodiment, the policy generation module 226 may define the promote capability as the identification of the capabilities that may be needed to make the stakeholders interested to perform a set of enterprise patent services. In said embodiment, the policy generation module 226 may define the protect capability as the capability at which the enterprise may need to protect the enterprise's patent portfolio. Further, the policy generation module 226 may also be configured to define the profit capability to be the capability that may be required to be attained in order to gain returns to the investments made to acquire IP rights, such as patents. The ‘3P×3P’ strategy would be described in greater detail in conjunction with FIG. 3.

In one implementation, the policy generation module 226 may be configured to generate a ‘RAM’ framework to implement the ‘3P×3P’ strategy. In said implementation, the policy generation module 226 may be configured to generate enterprise roles and hierarchy for implementing the various enterprise patent services and enterprise patent capabilities associated with the ‘3P×3P’ strategy. The association of a pair of enterprise patent capability and enterprise patent service with role may be a many-to-one relationship.

In said implementation, the policy generation module 226 may associate various set of activities with a role. The role owner is expected to perform the set of activities so as to develop the enterprise patent capabilities and deliver the enterprise patent services.

In one embodiment, the policy generation module 226 may be further configured to generate a set of measures which would serve as standard metrics for determining the progress of the enterprise in attaining maturity in various enterprise patent services associated with patent management. In one implementation, the policy generation module 226 may generate a ‘DEEP’ framework so as to define metrics for measuring and attaining maturity in implementation of the ‘3P×3P’ strategy. In one implementation, the generated DEEP framework comprises of four levels of attainment of maturity, namely Defined, Established, Excel, and Pioneer. In one implementation, the defined ‘DEEP’ framework may be stored as maturity model data 230. The following table, Table-1, defines the various levels of maturity, in accordance with one embodiment of the present subject matter.

TABLE 1

| Level of Maturity | Definition |
|---|---|
| Defined | At the said maturity level, the processes are planned and executed in |
| | accordance with defined guidelines. The processes are usually |
| | implemented by skilled professionals according to the process |
| | description. |
| Established | At the said maturity level, the processes are elaborately characterized |
| | and understood, and are described in form of standards, procedures, |
| | tools, and methods. |
| Excel | At the said maturity level, the enterprise has successfully implemented |
| | the processes and is obtaining the requisite output. At this maturity |
| | level, the quality and process performance have attained the requisite |
| | enterprise standards. |
| Pioneer | At this maturity level, the enterprise has established itself as a market |
| | leader. The processes and methods adopted by the enterprise serve as |
| | model implementations for other key players. |

The patent management system 102 further includes the assessment module 228 configured to determine the maturity level of the enterprise in various aspects of patent management. In one implementation, the assessment module 228 may be configured to determine if a pair of enterprise patent service and enterprise patent capability has attained the objective required at various maturity levels. Moreover, in one implementation, the assessment module 228 may be configured to determine the overall status of maturity level achievement for all pairs of enterprise patent service and enterprise patent capability. Table 2 depicts an exemplary report and rule definition for determining maturity level of patent management in the enterprise.

TABLE 2
Patent Management Maturity Assessment:
Applicable at Business Unit or Enterprise Level

| Enterprise | Enterprise | | | | |
|---|---|---|---|---|---|
| patent | patent | | | | |
| capability | service | Maturity Level (ML) | | | |
| (EC) | (ES) | Defined | Established | Excel | Pioneer |
| Promote | Portfolio | R/A/G | R/A/G | R/A/G | R/A/G |
| Promote | Process | R/A/G | R/A/G | R/A/G | R/A/G |
| Promote | Program | R/A/G | R/A/G | R/A/G | R/A/G |
| Protect | Portfolio | R/A/G | R/A/G | R/A/G | R/A/G |
| Protect | Process | R/A/G | R/A/G | R/A/G | R/A/G |
| Protect | Program | R/A/G | R/A/G | R/A/G | R/A/G |
| Profit | Portfolio | R/A/G | R/A/G | R/A/G | R/A/G |
| Profit | Process | R/A/G | R/A/G | R/A/G | R/A/G |
| Profit | Program | R/A/G | R/A/G | R/A/G | R/A/G |

| | | | | |
|---|---|---|---|---|
| Overall Assessment Status | R/A/G | R/A/G | R/A/G | R/A/G |

Rule Definition for Maturity Level (ML) assessment of pair (EC, ES)

| | |
|---|---|
| R (indicating Red) | The given duplet of (EC, ES) has not |
| | achieved the objective at this ML |
| A (Indicating Amber) | The given duplet of (EC, ES) has achieved |
| | the objective at this ML |
| G (Indicating Green) | The given duplet pair of (EC, ES) has |
| | strongly achieved the objective at this ML |

Rule Definition for Overall Assessment
Status at each Maturity Level (ML)

| | Objective | |
|---|---|---|
| Represen- | Achievement | |
| tation | Status | Rule |
| Red | Not Achieved | At least one cell in this |
| | | ML or previous ML is red |
| Amber | Achieved | No cell in this ML and no |
| | | previous ML is red |
| Green | Strongly | All cells in this ML and |
| | Achieved | previous ML are green |

Further, the report generation module 229 facilitate the generation of various reports and analysis carried out by the various modules 208 of the patent management system 102. The various reports may be in form of documents, spreadsheets, tabular form, charts, dashboards, and so on. The tables 3a and 3b depict exemplary reports generated by the report generation module 229.

TABLE 3a
Patent Management Maturity Assessment:
Example: Business Unit - XX Services

| Enterprise | Enterprise | | | | |
|---|---|---|---|---|---|
| patent | patent | | | | |
| capability | service | Maturity Level (ML) | | | |
| (EC) | (ES) | Defined | Established | Excel | Pioneer |
| Promote | Portfolio | Amber | Amber | Red | Red |
| Promote | Process | Green | Green | Amber | Red |
| Promote | Program | Amber | Amber | Red | Red |
| Protect | Portfolio | Red | Red | Red | Red |
| Protect | Process | Amber | Amber | Amber | Red |
| Protect | Program | Amber | Amber | Red | Red |
| Profit | Portfolio | Red | Red | Red | Red |
| Profit | Process | Amber | Amber | Red | Red |
| Profit | Program | Red | Red | Red | Red |

| | | | | |
|---|---|---|---|---|
| Overall Assessment Status | Red | Red | Red | Red |

TABLE 3b
Patent Management Maturity Assessment:
Example: Business Unit - XYZ Services

| Enterprise | Enterprise | | | | |
|---|---|---|---|---|---|
| patent | patent | | | | |
| capability | service | Maturity Level (ML) | | | |
| (EC) | (ES) | Defined | Established | Excel | Pioneer |
| Promote | Portfolio | Green | Green | Amber | Red |
| Promote | Process | Green | Green | Amber | Amber |
| Promote | Program | Green | Green | Red | Red |
| Protect | Portfolio | Green | Green | Amber | Red |
| Protect | Process | Green | Green | Amber | Amber |
| Protect | Program | Green | Green | Red | Red |
| Profit | Portfolio | Green | Amber | Amber | Red |
| Profit | Process | Green | Green | Amber | Amber |
| Profit | Program | Green | Amber | Red | Red |

| | | | | |
|---|---|---|---|---|
| Overall Assessment Status | Green | Amber | Red | Red |

In one implementation, the patent management system 102 may be communicatively coupled with a content and document management system 240, a database and file management system 242 of the enterprise. In one implementation, the content and document management system 240 is configured to maintain various internal/external data about protection, valuation, usage of the patent and documents generated during the life cycle of the patent along with the relevant document versions. In said implementation, the database and file management system 242 is configured to organize the data/documents maintained by the content and document management system 240 for storage, retrieval and reporting purposes.

In another implementation, the content and document management system 240 and the file management system 242 may be included within the patent management system 102. Thus the patent management system 102 facilitates defining and implementing various frameworks, workflows, strategy, etc., for managing patents in the enterprise.

FIG. 3 illustrates a framework 300 for managing patents in an enterprise, according to an embodiment of the present subject matter. In said implementation, the framework includes the ‘3P×3P’ strategy framework 302, the RAM framework 304 and the DEEP framework 306. In said implementation, the ‘3P×3P’ strategy framework 302 further includes an enterprise patent capabilities set 308 and an enterprise patent services set 310.

As mentioned earlier, in one implementation, the enterprise patent capabilities set 308 include promote capabilities 312, protect capabilities 314 and profit capabilities 316, whereas the enterprise patent services set 310 may include the portfolio services 318, process services 320, and program services 322. The Table-4 below depicts an exemplary mapping of objectives of the enterprise patent services set 310 and the enterprise patent capabilities set 308.

TABLE 4
Mapping of Objectives

| Enterprise | Enterprise Services | | |
|---|---|---|---|
| Capabilities | Portfolio | Process | Program |
| Promote | Stratified | Idea-to-IDF-to-Filing | Competency & |
| | Inventions | | Incentives |
| Protect | Business Aligned | Zero Litigation | Landscaping & |
| | Clusters | Footprint | Mining |
| Profit | Patent Led | Investment-to-RoI | Valuation & |
| | Offerings | | Monetization |

As mentioned earlier, in one implementation, the policy generation module 226 generates the RAM framework 304 to implement the 3P×3P′ strategy framework 302. In one implementation, the RAM framework 304 may include various roles 324, indicative of various work positions in the enterprise. In one implementation, the roles 324 may include various role levels, indicative of the position of the role in the hierarchical ladder of the enterprise. Further, the role levels may include generic designations. Each of the generic designations may have one or more specific designations according to responsibilities, operational unit of the enterprise, relevant experience in years, etc. The table-5 below depicts an exemplary definition of roles 324 in the enterprise.

TABLE 5

| Role | Generic | Experi- | |
|---|---|---|---|
| Level | Designation | ence | Exemplary specific designation |
| Head | IP Program | 18+ | IP Program Head - New Product |
| | Head | Years | Initiative |
| Manager | Lead IP | 15+ | Lead IP Manager - Life Sciences |
| | Manager | Years | Unit |
| | IP Manager | 12+ | IP Manager - Financial Services |
| | | Years | Unit |
| Consultant | Lead IP | 10+ | Lead IP Consultant - Legal & |
| | Consultant | Years | Compliance |
| | IP Consultant | 08+ | IP Consultant - Research & Mining |
| | | Years | |
| Analyst | Lead IP | 04+ | Lead IP Analyst - Search & |
| | Analyst | Years | Analytics |
| | IP Analyst | 01+ | IP Analyst - Search & Analytics |
| | | Years | |

As mentioned earlier, each of the roles 324 may be mapped with one or more activities 326 of the RAM framework 304. The activities 326 are indicative of tasks that may be carried out by the roles 324 to attain enterprise patent capabilities 308 and deliver enterprise patent services 310. In one implementation, the activities 326 may be categorized into various classes such as common activities (CA), legal and compliance (LC), search and analytics (SA) and research and mining (RM). For example, the common activities (CA) may include IP learning, IP protection, IP administration, IP process, IP policies and guidelines, marketing and branding, etc. The Table-6 below depicts an exemplary mapping of activities 326 with role 324.

TABLE 6
Enterprise patent service - Portfolio, Enterprise patent
capability - Promote, Maturity Level - Defined

| | Category | Assigned |
|---|---|---|
| | of | to |
| List of Activity | Activity | Role |
| Training on Patent Search and Analytics | SA | IP Analyst |
| Training on Patent Claims Understanding | LC | IP Analyst |
| and Drafting | | |
| Basic Training on Landscape Analysis and | RM | IP Consultant |
| FTO | | |
| Define IP need for each Business Initiative | CA | IP Head |
| Study the current IP portfolio of the | RM | IP Consultant |
| enterprise and map to Business Initiatives | | |
| Study the IP practices and IP assets of | RM | IP Consultant |
| Key Players | | |
| Plan the desired IP clusters to strengthen | CA | IP Manager |
| Business Initiatives | | |
| Initiate Idea-to-Filing Process for new | CA | IP Analyst |
| IP creation | | |
| Initiate Positioning of existing IP that | CA | IP Consultant |
| is mapped to Business Initiatives | | |
| Initiate the License-In and FTO discussion | LC | IP Head |

Further, the measure 328 provides for various metrics for determining the maturity level of the enterprise in patent management. In one implementation, the measure 328 is in form of a dimensional model of measures, wherein the model provides for measuring every metric type against every dimension. In said implementation, some metric types may be measured against selected dimensions. The metric type denotes the category of the metrics, whereas the list of measures indicates the items whose measures are being considered. Further, the dimensions provide the measures across various categories such as business unit, subject area, and jurisdiction. The Table-7 below depicts an exemplary model of the measure 328.

TABLE 7

| Dimensional Modeling of Measures | | Dimensions | | | | | | | |
|---|---|---|---|---|---|---|---|---|---|
| Metric Type | List of Measures | Business Unit | Subject Area | Initiatives | Jurisdiction | Location | Attorney | Inventor | Time |
| Counts | Ideas, IDFs, | Yes | Yes | Yes | Yes | No | No | Yes | Yes |
| | Technical Notes, | | | | | | | | |
| | Filed, Granted, | | | | | | | | |
| | Retired, Under | | | | | | | | |
| | Litigation, Closed | | | | | | | | |
| | Litigation | | | | | | | | |
| Conversion | Idea-to-IDF, Idea-to- | Yes | Yes | Yes | Yes | No | No | Yes | Yes |
| Rate | Technical Note, IDF- | | | | | | | | |
| | to-File, File-to-Grant | | | | | | | | |
| Average Time | Idea-to-IDF, Idea-to- | Yes | Yes | Yes | Yes | No | No | Yes | Yes |
| Elapsed | Technical Note, IDF- | | | | | | | | |
| | to-File, File-to-Grant | | | | | | | | |
| Due Dates | Internal Due Dates, | Yes | Yes | Yes | Yes | No | Yes | Yes | Yes |
| | Office Action Due Dates, | | | | | | | | |
| | Litigation Due Dates | | | | | | | | |
| Expenses Spent | Filing, Maintenance, | Yes | Yes | Yes | Yes | No | No | No | Yes |
| | Consulting, Litigation, | | | | | | | | |
| | Administration | | | | | | | | |
| Expense | Filing, Maintenance, | Yes | Yes | Yes | Yes | No | No | No | Yes |
| Projection | Consulting, Litigation, | | | | | | | | |
| | Administration | | | | | | | | |
| Valuation | Projected vs. | Yes | Yes | Yes | Yes | No | No | Yes | Yes |
| | Realized, Projection | | | | | | | | |
| Training | Awareness, Search, | Yes | Yes | Yes | No | Yes | No | No | Yes |
| Program Count | Landscaping, Valuation | | | | | | | | |
| Training | Awareness, Search, | Yes | Yes | Yes | No | Yes | No | No | Yes |
| Participant | Landscaping, | | | | | | | | |
| Count | Valuation | | | | | | | | |
| Attorney | Filed, Granted, Fees, | No | Yes | No | Yes | No | Yes | No | Yes |
| Performance | Objection Handled, | | | | | | | | |
| | Litigation Handled, | | | | | | | | |
| | Expenses spent on | | | | | | | | |
| | Litigation | | | | | | | | |
| Incentive | Certificates, | Yes | Yes | Yes | No | No | No | Yes | Yes |
| | Felicitation, | | | | | | | | |
| | Financial Rewards | | | | | | | | |
| Trends | Counts, Conversion | Yes | Yes | Yes | Yes | No | No | Yes | Yes |
| | Rate, Average | | | | | | | | |
| | Elapsed time | | | | | | | | |

In one implementation, the DEEP framework 306 provides defined metrics for determining the maturity level of the enterprise for each enterprise patent service and each enterprise patent capability. The Table-8 below depicts exemplary definitions of enterprise patent services at various maturity levels as defined by the DEEP framework 306.

TABLE 8

| Enterprise | | | | |
|---|---|---|---|---|
| patent | Level of Maturity | | | |
| service 310 | Defined 330 | Established 332 | Excel 334 | Pioneer 336 |
| Portfolio | Enterprise | Enterprise | IP clusters are | IP strategy is an |
| 318 | defines and | matures to build | packaged under | integral part of |
| | plans IP | IP clusters around | product, service | Enterprise's |
| | aligned to | its business | and process | business |
| | business | initiatives | offerings | strategy & plan |
| | initiatives | | | |
| Process | IP policy, | IP processes | Measures are | Matured |
| 320 | guidelines, | automated | tracked for audit, | processes |
| | processes & | through system to | compliance and | leading to |
| | system defined | facilitate IP | optimization | optimized Idea- |
| | and released | promotion, | | to-Filing, Zero |
| | | protection and | | Litigation and |
| | | valuation | | higher RoI |
| Program | IP | Enterprise | Enterprise | Matured IP |
| 322 | Competency | performs IP | performs | Program |
| | and Incentive | mining and | standalone and | running as a |
| | program is | landscaping to | cluster valuation of | business unit |
| | defined and is | support business | IP and its | with direct and |
| | under | initiatives | monetization | joint P&L |
| | execution | | | targets |

Thus, from the above description, it is understood that the ‘3P×3P’ strategy framework 302 provides for definitions for mapping of each member of the enterprise patent services set 310 with each member of the enterprise patent capabilities set 308. Further, in accordance with the DEEP framework 306, each service defined in the enterprise patent services set 310 may have four levels of maturity. Based on the same, in one implementation, the policy generation module 226 may be configured to generate definitions of objectives for each triplet of enterprise patent service, enterprise patent capability and maturity level. The Table-9 below depicts an exemplary set of objectives for each triplet of enterprise patent service, enterprise patent capability and maturity level.

TABLE 9

| Enterprise patent capability × | |
|---|---|
| Enterprise patent service × | |
| Maturity Level | Objective |
| Promote × Portfolio × Defined | Planning stratified IP aligned to business initiatives |
| Promote × Portfolio × | Practicing cluster IP creation aligned to business initiatives |
| Established | |
| Promote × Portfolio × Excel | Leveraging IP portfolio through business portfolio |
| Promote × Portfolio × Pioneer | Optimizing business results through IP led business |
| | strategy |
| Promote × Process × Defined | Defining process for business aligned IP creation |
| Promote × Process × | Executing process for business aligned IP creation |
| Established | |
| Promote × Process × Excel | Measurements, reporting and trend analysis for IP portfolio |
| | improvement |
| Promote × Process × Pioneer | Process driven matured IP portfolio aligned to business |
| | initiative |
| Promote × Program × Defined | Competency & Incentive for promoting invention |
| Promote × Program × | Competency & Incentive for promoting inventions in |
| Established | business aligned clusters |
| Promote × Program × Excel | Competency & Incentive for IP valuation and realization |
| Promote × Program × Pioneer | Competency & Incentive for integrating IP with business |
| | strategy |
| Protect × Portfolio × Defined | Protection plan for stratified IP aligned to business |
| | initiatives |
| Protect × Portfolio × | Practicing protection for cluster IP aligned to business |
| Established | initiatives |
| Protect × Portfolio × Excel | Protecting IP led product, service and process offerings |
| Protect × Portfolio × Pioneer | Advisory on protection strategy supporting business |
| | strategy |
| Protect × Process × Defined | Defining process for zero litigation footprint |
| Protect × Process × | Executing process for zero litigation footprint |
| Established | |
| Protect × Process × Excel | Measurements, reporting and trend analysis on zero |
| | litigation footprint |
| Protect × Process × Pioneer | Matured and Predictable IP processes that minimizes |
| | litigation |
| Protect × Program × Defined | Landscaping and Mining on IP related to business initiative |
| Protect × Program × | Building fencing capability with initiative aligned cluster |
| Established | IP |
| Protect × Program × Excel | Factoring landscaping and mining input into valuation of |
| | IP and cluster IP to optimize valuation |
| Protect × Program × Pioneer | Landscaping and Mining as key differentiator for business |
| | driven IP program |
| Profit × Portfolio × Defined | Aligning stratified IP to offerings |
| Profit × Portfolio × | Aligning cluster IP to offerings |
| Established | |
| Profit × Portfolio × Excel | Realizing differentiating economic value through patent |
| | led offerings |
| Profit × Portfolio × Pioneer | Optimizing economic value through IP led business |
| | strategy |
| Profit × Process × Defined | Investment-to-Return on Investment (RoI) process defined |
| Profit × Process × Established | Investment-to-RoI process adopted |
| Profit × Process × Excel | Measurements, reporting and trend analysis on investment |
| | & RoI |
| Profit × Process × Pioneer | Optimizing the investment & RoI throughout the |
| | investment-to-RoI process cycle |
| Profit × Program × Defined | Competency & Incentive plan for effective valuation and |
| | monetization of IP |
| Profit × Program × | Lift in valuation and monetization through landscape |
| Established | analysis and IP mining |
| Profit × Program × Excel | Lift in valuation and monetization through landscape |
| | analysis and IP mining with cluster based strategy |
| Profit × Program × Pioneer | Lift in P&L that is attributed to IP based business strategy |

It will be appreciated that the objectives as defined in Table 9 may be derived by various techniques by combination of the definitions mentioned in the Tables 4 and 8. The Table-10 depicts and exemplary derivation the definitions of objectives stated in Table-9.

TABLE 10
Derivation of Objective (Enterprise patent capability (EC), Enterprise
patent service (ES), Maturity Level (ML)) - Mapping Table

| EC × ES Mapping | ES × ML Mapping | EC × ES × ML Mapping |
|---|---|---|
| Promote × Portfolio | Portfolio × Defined | Promote × Portfolio × |
| | | Defined |
| Stratified | Enterprise defines and plans IP | Planning stratified IP |
| Inventions | aligned to business initiatives | aligned to business |
| | | initiatives |
| Promote × Portfolio | Portfolio × Established | Promote × Portfolio × |
| | | Established |
| Stratified | Enterprise matures to build IP | Practicing cluster IP |
| Inventions | clusters around its business | creation aligned to business |
| | initiatives | initiatives |
| Promote × Portfolio | Portfolio × Excel | Promote × Portfolio × Excel |
| Stratified | IP clusters are packaged under | Leveraging IP portfolio |
| Inventions | product, service and process | through business portfolio |
| | offerings | |
| Promote × Portfolio | Portfolio × Pioneer | Promote × Portfolio × |
| | | Pioneer |
| Stratified | IP strategy is an integral part of | Optimizing business results |
| Inventions | Enterprise's business strategy & plan | through IP led business |
| | | strategy |
| EC × ES | ES × ML | EC × ES × ML |
| Promote × Process | Process × Defined | Promote × Process × |
| | | Defined |
| Idea-to-IDF-to- | IP policy, guidelines, processes & | Defining process for |
| Filing | system defined and released | business aligned IP creation |
| Promote × Process | Process × Established | Promote × Process × |
| | | Established |
| Idea-to-IDF-to- | IP processes automated through | Executing process for |
| Filing | system to facilitate IP promotion, | business aligned IP creation |
| | protection and valuation | |
| Promote × Process | Process × Excel | Promote × Process × Excel |
| Idea-to-IDF-to- | Measures are tracked for audit, | Measurements, reporting |
| Filing | compliance and optimization | and trend analysis for IP |
| | | portfolio improvement |
| Promote × Process | Process × Pioneer | Promote × Process × |
| | | Pioneer |
| Idea-to-IDF-to- | Matured processes leading to | Process driven matured IP |
| Filing | optimized Idea-to-Filing, Zero | portfolio aligned to business |
| | Litigation and higher RoI | initiative |
| Promote × Program | Program × Defined | Promote × Program × |
| | | Defined |
| Competency & | IP Competency and Incentive | Competency & Incentive for |
| Incentives | program is defined and is under | promoting invention |
| | execution | |
| Promote × Program | Program × Established | Promote × Program × |
| | | Established |
| Competency & | Enterprise performs IP mining and | Competency & Incentive for |
| Incentives | landscaping to support business | promoting inventions in |
| | initiatives | business aligned clusters |
| Promote × Program | Program × Excel | Promote × Program × Excel |
| Competency & | Enterprise performs standalone and | Competency & Incentive for |
| Incentives | cluster valuation of IP and its | IP valuation and realization |
| | monetization | |
| Promote × Program | Program × Pioneer | Promote × Program × |
| | | Pioneer |
| Competency & | Matured IP Program running as a | Competency & Incentive for |
| Incentives | business unit with direct and joint | integrating IP with business |
| | P&L targets | strategy |
| Protect × Portfolio | Portfolio × Defined | Protect × Portfolio × |
| | | Defined |
| Business Aligned | Enterprise defines and plans IP | Protection plan for stratified |
| Clusters | aligned to business initiatives | IP aligned to business |
| | | initiatives |
| Protect × Portfolio | Portfolio × Established | Protect × Portfolio × |
| | | Established |
| Business Aligned | Enterprise matures to build IP | Practicing protection for |
| Clusters | clusters around its business | cluster IP aligned to |
| | initiatives | business initiatives |
| Protect × Portfolio | Portfolio × Excel | Protect × Portfolio × Excel |
| Business Aligned | IP clusters are packaged under | Protecting IP led product, |
| Clusters | product, service and process | service and process |
| | offerings | offerings |
| Protect × Portfolio | Portfolio × Pioneer | Protect × Portfolio × Pioneer |
| Business Aligned | IP strategy is an integral part of | Advisory on protection |
| Clusters | Enterprise's business strategy & plan | strategy supporting business |
| | | strategy |
| Protect × Process | Process × Defined | Protect × Process × Defined |
| Zero Litigation | IP policy, guidelines, processes & | Defining process for zero |
| Footprint | system defined and released | litigation footprint |
| Protect × Process | Process × Established | Protect × Process × |
| | | Established |
| Zero Litigation | IP processes automated through | Executing process for zero |
| Footprint | system to facilitate IP promotion, | litigation footprint |
| | protection and valuation | |
| Protect × Process | Process × Excel | Protect × Process × Excel |
| Zero Litigation | Measures are tracked for audit, | Measurements, reporting |
| Footprint | compliance and optimization | and trend analysis on zero |
| | | litigation footprint |
| Protect × Process | Process × Pioneer | Protect × Process × Pioneer |
| Zero Litigation | Matured processes leading to | Matured and Predictable IP |
| Footprint | optimized Idea-to-Filing, Zero | processes that minimizes |
| | Litigation and higher RoI | litigation |
| Protect × Program | Program × Defined | Protect × Program × |
| | | Defined |
| Landscaping & | IP Competency and Incentive | Landscaping and Mining on |
| Mining | program is defined and is under | IP related to business |
| | execution | initiative |
| Protect × Program | Program × Established | Protect × Program × |
| | | Established |
| Landscaping & | Enterprise performs IP mining and | Building fencing capability |
| Mining | landscaping to support business | with initiative aligned |
| | initiatives | cluster IP |
| Protect × Program | Program × Excel | Protect × Program × Excel |
| Landscaping & | Enterprise performs standalone and | Factoring landscaping and |
| Mining | cluster valuation of IP and its | mining input into valuation |
| | monetization | of IP and cluster IP to |
| | | optimize valuation |
| Protect × Program | Program × Pioneer | Protect × Program × Pioneer |
| Landscaping & | Matured IP Program running as a | Landscaping and Mining as |
| Mining | business unit with direct and joint | key differentiator for |
| | P&L targets | business driven IP program |
| Profit × Portfolio | Portfolio × Defined | Profit × Portfolio × Defined |
| Patent Led | Enterprise defines and plans IP | Aligning stratified IP to |
| Offerings | aligned to business initiatives | offerings |
| Profit × Portfolio | Portfolio × Established | Profit × Portfolio × |
| | | Established |
| Patent Led | Enterprise matures to build IP | Aligning cluster IP to |
| Offerings | clusters around its business | offerings |
| | initiatives | |
| Profit × Portfolio | Portfolio × Excel | Profit × Portfolio × Excel |
| Patent Led | IP clusters are packaged under | Realizing differentiating |
| Offerings | product, service and process | economic value through |
| | offerings | patent led offerings |
| Profit × Portfolio | Portfolio × Pioneer | Profit × Portfolio × Pioneer |
| Patent Led | IP strategy is an integral part of | Optimizing economic value |
| Offerings | Enterprise's business strategy & plan | through IP led business |
| | | strategy |
| Profit × Process | Process × Defined | Profit × Process × Defined |
| Investment-to-RoI | IP policy, guidelines, processes & | Investment-to-RoI process |
| | system defined and released | defined |
| Profit × Process | Process × Established | Profit × Process × |
| | | Established |
| Investment-to-RoI | IP processes automated through | Investment-to-RoI process |
| | system to facilitate IP promotion, | adopted |
| | protection and valuation | |
| Profit × Process | Process × Excel | Profit × Process × Excel |
| Investment-to-RoI | Measures are tracked for audit, | Measurements, reporting |
| | compliance and optimization | and trend analysis on |
| | | investment & RoI |
| Profit × Process | Process × Pioneer | Profit × Process × Pioneer |
| Investment-to-RoI | Matured processes leading to | Optimizing the investment |
| | optimized Idea-to-Filing, Zero | & RoI throughout the |
| | Litigation and higher RoI | investment-to-RoI process |
| | | cycle |
| Profit × Program | Program × Defined | Profit × Program × Defined |
| Valuation & | IP Competency and Incentive | Competency & Incentive |
| Monetization | program is defined and is under | plan for effective valuation |
| | execution | and monetization of IP |
| Profit × Program | Program × Established | Profit × Program × |
| | | Established |
| Valuation & | Enterprise performs IP mining and | Lift in valuation and |
| Monetization | landscaping to support business | monetization through |
| | initiatives | landscape analysis and IP |
| | | mining |
| Profit × Program | Program × Excel | Profit × Program × Excel |
| Valuation & | Enterprise performs standalone and | Lift in valuation and |
| Monetization | cluster valuation of IP and its | monetization through |
| | monetization | landscape analysis and IP |
| | | mining with cluster based |
| | | strategy |
| Profit × Program | Program × Pioneer | Profit × Program × Pioneer |
| Valuation & | Matured IP Program running as a | Lift in P&L that is attributed |
| Monetization | business unit with direct and joint | to IP based business |
| | P&L targets | strategy |

Thus, the framework 302 for patent management in the enterprise facilitates sustaining and enhancing IP rights in the enterprise. The framework 302 further provides for aligning business objectives of the enterprise with acquiring of patent rights. Moreover, the framework 302 also provides for facilitating analysis of patent portfolio of the enterprise.

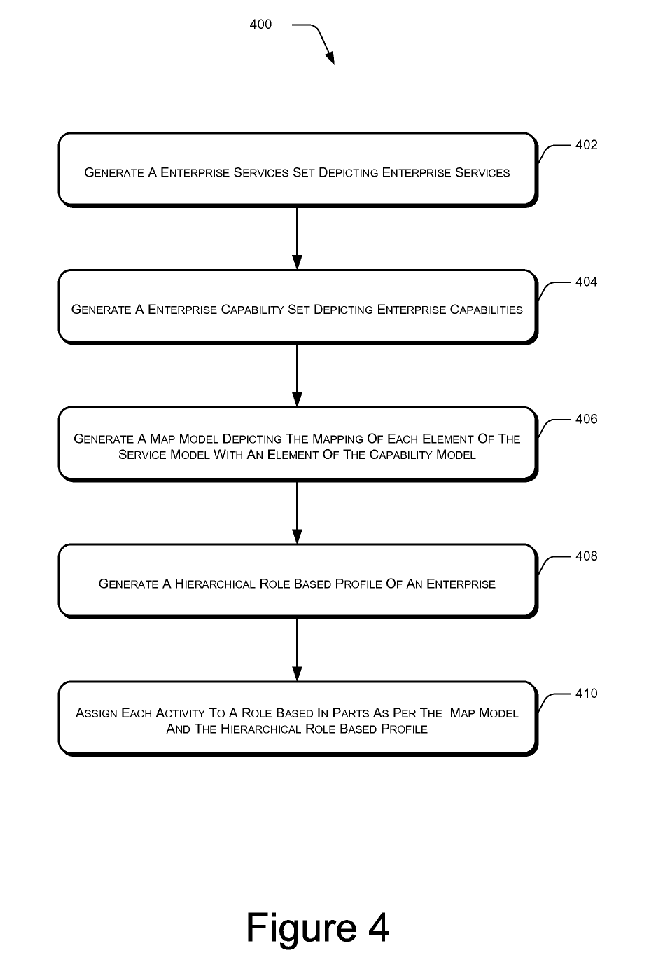

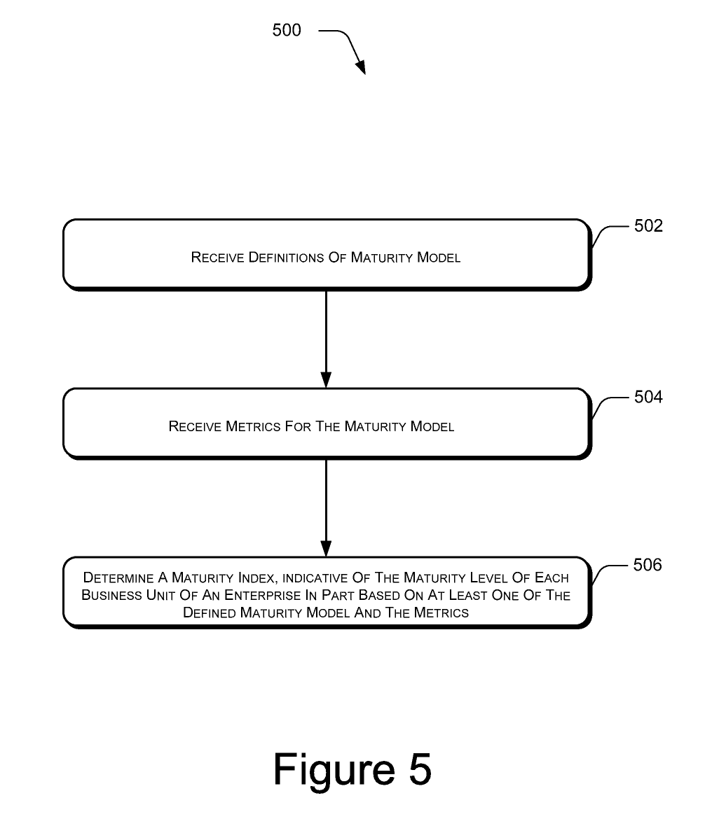

FIG. 4 illustrates an exemplary method 400 for generating a role based activity so as to facilitate patent management in an enterprise, according to an embodiment of the present subject matter, whereas FIG. 5 illustrates an exemplary computer implemented method 500 for determining a maturity index indicative of the maturity level of an enterprise in patent management, according to an embodiment of the present subject matter. The methods 400 and 500 may be described in the general context of computer executable instructions. Generally, computer executable instructions can include routines, programs, objects, components, data structures, procedures, modules, functions, which perform particular functions or implement particular abstract data types. The methods 400 and 500 may also be practiced in a distributed computing environment where functions are performed by remote processing devices that are linked through a communication network. In a distributed computing environment, computer executable instructions may be located in both local and remote computer storage media, including memory storage devices.

The order in which the methods 400 and 500 is described is not intended to be construed as a limitation, and any number of the described method blocks can be combined in any order to implement the methods 400 and 500, or alternative methods. Additionally, individual blocks may be deleted from the methods 400 and 500 without departing from the spirit and scope of the subject matter described herein. Furthermore, the methods 400 and 500 can be implemented in any suitable hardware, software, firmware, or combination thereof.

With reference to method 400 as depicted in FIG. 4, as shown in block 402, an enterprise patent service set comprising of enterprise patent services pertaining to patent management of an enterprise is generated. In one implementation, the policy generation module 226 is configured to generate an enterprise patent services set, such as the enterprise patent services set 310.

As illustrated instep 404, an enterprise patent capability set pertaining to capabilities of each of the services defined in the enterprise patent services set 310 is generated. In one implementation, the policy generation module 226 is configured to generate an enterprise patent capability set, such as the enterprise patent capability set 308.

As depicted in block 406, a mapping of each enterprise patent service with each enterprise patent capability is determined. In one implementation, the policy generation module 226 is may be configured to generate a mapping of objectives of the enterprise patent services set 310 and the enterprise patent capabilities set 308. An exemplary mapping, generated by the policy generation module 226, has been depicted in Table-4 earlier.

At block 408, a hierarchical position in form of role based profile is generated so as to facilitate the fulfillment of objectives defined in the mapping of the enterprise patent services set 310 and the enterprise patent capabilities set 308. The roles 324 may be indicative of various work positions in the enterprise. In one implementation, the roles 324 may include various role levels, indicative of the position of the role in the hierarchical ladder of the enterprise. In said implementation, the policy generation module 226 may be configured to generate the roles 324 based on various inputs, such as human resource policy of the enterprise, career path implemented by the enterprise, and skill set associated with each defined objective of the mapping of the enterprise patent services set 310 and the enterprise patent capabilities set 308. An exemplary table depicting hierarchical positions in form of roles as been depicted in the Table 5.

As illustrated in block 410, various activities are defined and are assigned to the defined roles based in part on the mapping and the hierarchical role based profile. In one implementation, the policy generation module 226 may be configured to assign activities to roles as depicted in Table 6. The assignment of activities to roles facilitates fulfillment of the objectives defined in the mapping of the enterprise patent services set 310 and the enterprise patent capabilities set 308.

With reference to method 500 as depicted in FIG. 5, as shown in block 502, the definition of a maturity model is received. In one embodiment, the received maturity model defines objectives to be attained for every combination of enterprise patent service and enterprise patent capability at each maturity level as defined in the ‘DEEP’ framework.

As illustrated in block 504, the metrics for determining the maturity level attained by the enterprise in patent management is received. In one implementation, the metrics may be received in the form of Table-7.

As depicted in block 506, a maturity index is generated, indicate of the maturity level attained by each business unit of the enterprise, and by the enterprise as a whole in patent management. In one implementation, the report generation module 229 may be configured to generate various reports and transmit the same to an assessment module 228. The assessment module 228 may assign various weightage parameters to each of the metrics mentioned in the report to generate the maturity index.

Thus the patent management system 102 facilitates. The systems and method for managing patents as described in the present subject matter are generic and platform independent and thus can be used for various types of systems.

We claim:

1. A method for managing patents in an enterprise, the method comprising:
defining, using a processor of a patent management system, an enterprise patent service set of a plurality of enterprise patent services, wherein the enterprise patent services set comprises portfolio service, process service, and program service;
defining, using the processor, an enterprise patent capability set of a plurality of enterprise patent capabilities, for delivering each of the enterprise patent services in the enterprise patent service set, wherein the enterprise patent capability set comprises promote, protect and profit;
mapping, using the processor, each of the enterprise patent services in the enterprise patent service set with each of the enterprise patent capabilities in the enterprise patent capability set to generate an objective for each pair of enterprise patent service and enterprise patent capability; and
generating, using the processor, a maturity index, indicative of the maturity level of the enterprise in patent management, based in part on the mapping.

2. The method as claimed in claim 1, wherein the method further comprises defining an objective by mapping one of the plurality of enterprise patent services and one of the plurality of enterprise patent capabilities.

3. The method as claimed in claim 1, wherein the method further comprises:
defining a plurality of roles for managing patents;
defining a plurality of activities for managing patents wherein each of the plurality of activities may be categorized as at least one of common activities (CA), legal and compliance (LC), search and analytics (SA) and research and mining (RM);
assigning at least one of the plurality of activities to each of the plurality of roles based in part on experience, and responsibilities associated with each role; and
defining a set of measures for determining the maturity level of each of the plurality of activities.

4. The method as claimed in claim 1, wherein the method further comprises defining a plurality of maturity levels, wherein the plurality of maturity levels comprises a defined maturity level, an established maturity level, an excel maturity level and a pioneer maturity level.

5. The method as claimed in claim 4, wherein the method further comprises defining an objective for each triplet generated by combining one of the plurality of enterprise patent services, one of the plurality of enterprise patent capabilities, and one of the plurality of maturity levels.

6. The method as claimed in claim 4, wherein the method further comprises defining an objective by mapping one of the plurality of enterprise patent services and one of the plurality of maturity levels.

7. The method as claimed in claim 4, wherein the method further comprises defining a dimensional model of measures for determining a maturity index indicative of the maturity level of patent management in the enterprise.

8. The method as claimed in claim 4, wherein the method further comprises generating at least one report indicative of a maturity level of a duplet of one of the plurality of enterprise patent services and one of the plurality of enterprise patent capabilities.

9. The method as claimed in claim 1, wherein the method further comprises generating at least one report indicative of a maturity level of patent management in the enterprise, based in part on at least one enterprise patent service and one enterprise patent capability.

10. A patent management system configured for managing patents in an enterprise, comprising:
a processor; and
a memory coupled to the processor, the memory comprising:
a policy generation module configured to
define an enterprise patent service set of a plurality of enterprise patent services, wherein the enterprise patent services set comprises portfolio service, process service, and program service;
define an enterprise patent capability set of a plurality of enterprise patent capabilities, for delivering each of the enterprise patent services in the enterprise patent service set, wherein the enterprise patent capability set comprises promote, protect and profit; and
map each of the enterprise patent services in the enterprise patent service set with each of the enterprise patent capabilities in the enterprise patent capability set to generate an objective for each pair of enterprise patent service and enterprise patent capability; and
an assessment module configured to determine the maturity level of a duplet of one of the plurality of enterprise patent services and one of the plurality of enterprise patent capabilities.

11. The patent management system as claimed in claim 10, wherein the policy generation module is further configured to:
define a plurality of roles for managing patents;
define a plurality of activities for managing patents wherein each of the plurality of activities may be categorized as at least one of common activities (CA), legal and compliance (LC), search and analytics (SA) and research and mining (RM); and
assign at least one of the plurality of activities to each of the plurality of roles based in part on experience, and responsibilities associated with each role.

12. The patent management system as claimed in claim 10, wherein the policy generation module is further configured to define a plurality of maturity levels of patent management, wherein the plurality of maturity levels comprises a defined maturity level, an established maturity level, an excel maturity level and a pioneer maturity level.

13. The patent management system as claimed in claim 10, further comprising a patent administration module configured to generate at least one of an idea to Invention Disclosure File (IDF) workflow, an IDF to filing of patent application workflow, a prosecution workflow, a litigation workflow, an incentive management workflow, an expense management, and an attorney interaction management workflow.

14. The patent management system as claimed in claim 10, further comprising a portfolio development module configured to perform at least one of a landscape analysis, a whitespace analysis, and a patent portfolio to product mapping.

15. The patent management system as claimed in claim 10, further comprising a patent valuation module configured to determine the valuation of a patent portfolio of the enterprise.

16. The patent management system as claimed in claim 10, wherein the assessment module is further configured to determine the maturity level of patent management in the enterprise.

17. The patent management system as claimed in claim 10, further comprising a report generation module configured to generate at least one report indicative of a maturity level of a duplet of one of the plurality of enterprise patent services and one of the plurality of enterprise patent capabilities.

18. The patent management system as claimed in claim 10, further comprising a report generation module configured to generate at least one report indicative of a maturity level of patent management in the enterprise, based in part on at least one enterprise patent service and one enterprise patent capability.

19. A non-transitory computer-readable medium having embodied thereon a computer program for executing a method for managing patents in an enterprise, the method comprising:
defining an enterprise patent service set of a plurality of enterprise patent services, wherein the enterprise patent services set comprises portfolio service, process service, and program service;
defining an enterprise patent capability set of a plurality of enterprise patent capabilities, for delivering each of the enterprise patent services in the enterprise patent service set, wherein the enterprise patent capability set comprises promote, profit and protect; and
mapping each of the enterprise patent services in the enterprise patent service set with each of the enterprise patent capabilities in the enterprise patent capability set to generate an objective for each pair of enterprise patent service and enterprise patent capability.
